(19) United States
(12) Patent Application Publication
(10) Pub. No.: US 2025/0047167 A1
(43) Pub. Date: Feb. 6, 2025

(54) Flywheel Power Generation System and Exercise Bike

(71) Applicant: Huan-Yu Cheng, Taipei (TW)

(72) Inventor: Huan-Yu Cheng, Taipei (TW)

(21) Appl. No.: 18/586,643

(22) Filed: Feb. 26, 2024

(30) Foreign Application Priority Data
Aug. 1, 2023 (CN) 2023220470432

(51) Int. Cl. H02K 7/18; A63B 21/22; A63B 22/06; H02K 7/02; H02K 7/102; H02K 7/116; H02K 11/00; H02K 11/22

(52) U.S. Cl. CPC H02K 7/1853; A63B 21/225; A63B 22/06; H02K 7/02; H02K 7/102; H02K 7/116; H02K 11/0094; H02K 11/22

(57) ABSTRACT

A flywheel power generation system and an exercise bike are disclosed. The flywheel power generation system includes a rotating shaft, a flywheel, a bracket, a stator coil, a first brake member, a second brake member and a driving device set. The driving device set drives a first movable end and a second movable end toward or away from each other to adjust the gap between the first brake member/second brake member and the magnet set, thereby adjusting the riding resistance. When the flywheel rotates, the magnet set passes through the stator coil to cut the magnetic field to generate electromotive force so as to form an induced current, that is, to generate electrical energy. The resistance adjustment mechanism and the power generation mechanism in the flywheel power generation structure share the same magnet set, making the flywheel power generation system compact and low-cost.

### BACKGROUND AND SUMMARY OF THE INVENTION

The present invention relates to the technical field of fitness equipment, and in particular to a flywheel power generation system and an exercise bike.

Indoor exercise bikes are becoming more and more popular due to their small footprint, combined aerobic and anaerobic exercise modes, similar riding methods to bicycles, and movements that do not harm the knee joints.

In order to save energy consumption, in the existing technology, a generator is installed on the exercise bike to convert the kinetic energy of the exercise bike into electrical energy for use by the exercise bike itself, or, the electricity generated by the generators of multiple bicycles can be stored in batteries for use by other electrical appliances in the fitness venue.

For example, in the technology of Chinese patent document CN218958717U, a power generation device for an exercise bike comprises a bracket, a flywheel, an annular magnet and generator coils. The flywheel is rotated on the bracket through a rotating bearing. The annular magnet is set on the flywheel and has a concentric structure with the flywheel. The ring magnet comprises several pairs of NS magnetic poles arranged along the circumferential direction, and the N and S poles of the NS magnetic poles are staggered. The generator coils include several groups and are arranged on the bracket on one side of the annular magnet for cutting the magnetic field of the annular magnet. In practical applications, the flywheel is connected to the pedals of the exercise bike. When the pedals of the exercise bike are stepped on, the flywheel rotates. When the annular magnet rotates with the flywheel, the N-pole and S-pole magnetic fields of the annular magnet quickly stagger through the generator coils. Due to the principle of magnetic electricity generation, when a part of the conductor in the closed circuit of the generator moves to cut the magnetic field lines, electromagnetic induction occurs in the conductor and an induced current is generated, so that the generator can generate electricity.

However, the above solution requires a magnet on the outside of the flywheel and generator coils on the bracket, which requires large space and high cost.

Therefore, the above problems need to be solved urgently.

### SUMMARY OF THE INVENTION

In view of this, the inventor of the present invention finally created and designed this flywheel power generation system and exercise bike after continuous research, improvement and testing.

Therefore, the main object of the present invention is to provide a flywheel power generation system and an exercise bike that drive a first movable end and a second movable end toward or away from each other through a driving device set, so that the gap between a first brake member, a second brake member and a magnet set can be adjusted, and the riding resistance can be adjusted.

Another object of the present invention is to drive the magnet set to rotate synchronously when the flywheel rotates, so that when the magnet set passes through the stator coil, it cuts the magnetic field to generate electromotive force to form an induced current, that is, to generate electrical energy.

Still another object of the present invention is that the resistance adjustment mechanism and the power generation mechanism in the flywheel power generation structure share the same magnet set, so that the flywheel power generation system has a compact structure and low cost.

Still another object of the present invention is to use accommodating chamber on the flywheel to accommodate components such as magnet set, first brake member, second brake member, etc., so that the structure of the flywheel power generation system can be made more compact, and certain components in the flywheel power generation system can be shared, with low cost and easy assembly.

### BRIEF DESCRIPTION OF THE DRAWING

FIG. 1 is a schematic structural diagram of the flywheel system provided by the present invention.

FIG. 2 is a schematic structural diagram of the flywheel system provided by the present invention without the fixing member.

FIG. 3 is a partial enlarged view of FIG. 2.

### DETAILED DESCRIPTION OF THE INVENTION

The present invention will be further described in detail below in conjunction with the accompanying drawings and embodiment.

In view of the above-mentioned previous technology, it is necessary to provide magnets outside the flywheel 20 and a motor 91 coil on the bracket 2, which requires large space and high cost.

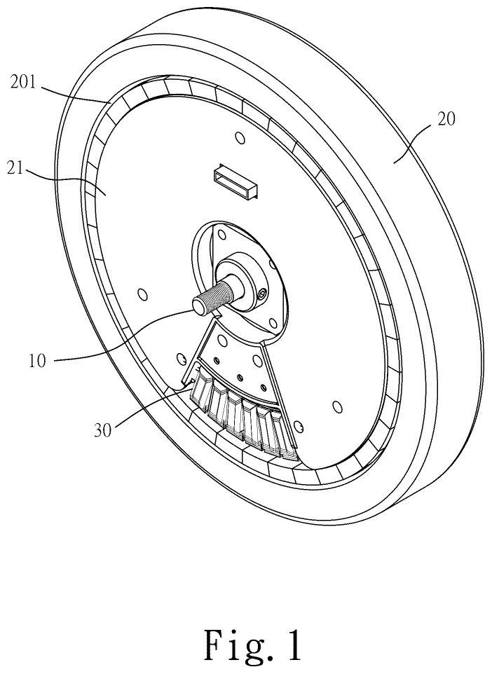

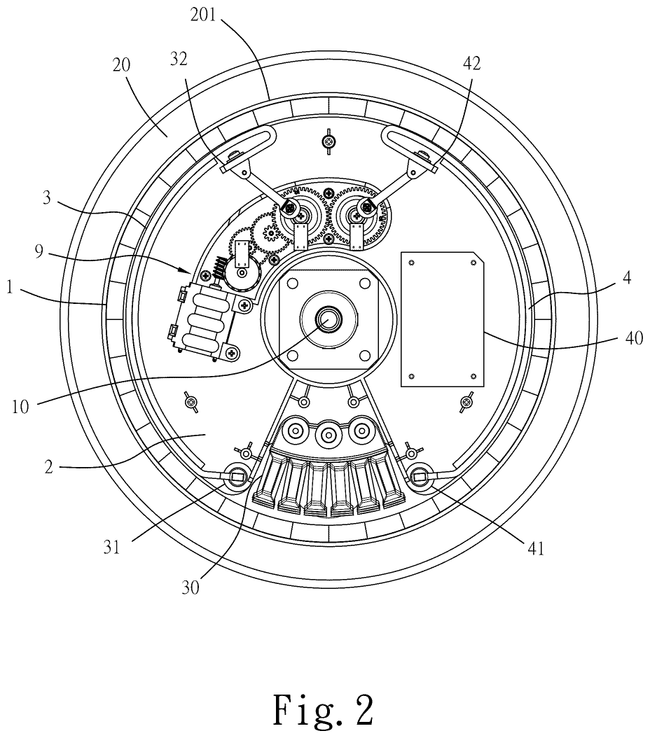

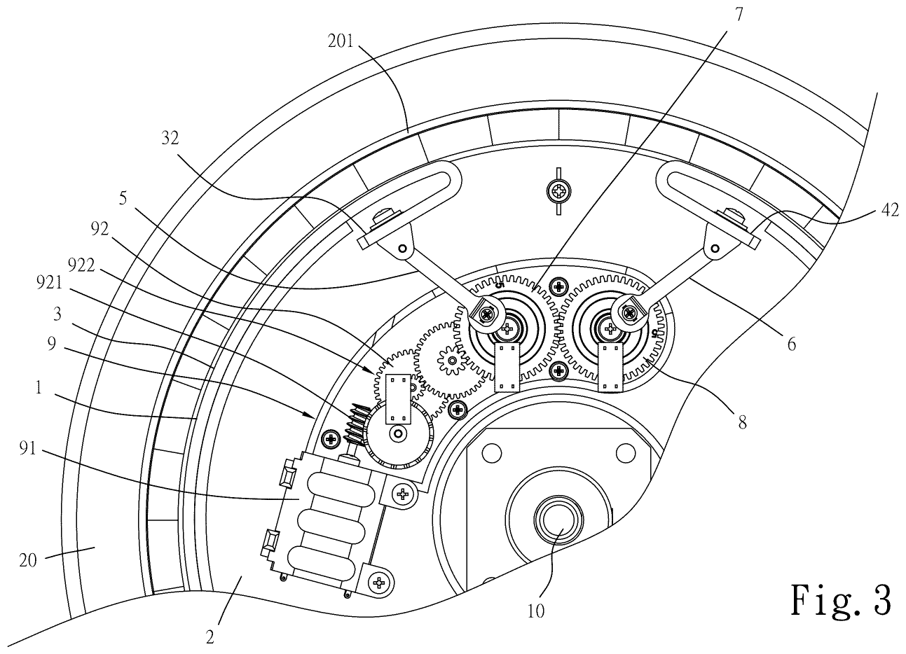

In order to solve the above problems, please refer to FIGS. 1 to 3. The embodiment of the present invention provide a flywheel power generation system and an exercise bike. The flywheel power generation system comprises a rotating shaft 10, a flywheel 20, a bracket 2, a stator coil 30, a first brake member 3, a second brake member 4 and a driving device set 9. The rotating shaft 10 is driven to rotate by the pedal mechanism on the exercise bike. The specific connection method is an existing technology and will not be described in detail in this embodiment. The flywheel 20 is fixedly connected to the rotating shaft 10, so that the user can drive the flywheel 20 to rotate through the pedals to achieve the purpose of exercise.

The flywheel 20 is fixedly connected to the rotating shaft 10. The flywheel 20 has a circular accommodating chamber 201. The magnet set 1 is fixedly installed on the circumferential groove wall of the accommodating chamber 201. The bracket 2 is rotatably connected to the rotating shaft 10, and the bracket 2 is located in the accommodating chamber 201. The stator coil 30 is fixedly installed on the bracket 2. The first brake member 3 is arranged in an arc shape. The first brake member 3 comprises a first fixed end 31 and a first movable end 32. The first fixed end 31 is rotatably installed on the bracket 2. The second brake member 4 is arranged in an arc shape. The second brake member 4 comprises a second fixed end 41 and a second movable end 42. The second fixed end 41 is rotatably installed on the bracket 2. The first brake member 3 and the second brake member 4 can cooperate to achieve an arc profile similar to the magnet set 1. The driving device set 9 is configured to drive the first movable end 32 and the second movable end 42 towards or away from each other.

It can be understood that the driving device set 9 drives the first movable end 32 and the second movable end 42 to move closer or farther away from each other, that is, the gap between the first brake member 3, the second brake member 4 and the magnet set 1 can be adjusted, and the riding resistance can be adjusted. It is also understandable that when the flywheel 20 rotates, it can drive the magnet set 1 to rotate synchronously. When the magnet set 1 passes through the stator coil 30, it cuts the magnetic field to generate electromotive force to form an induced current, that is, to generate electrical energy. It can be known from this that the resistance adjustment mechanism in the flywheel 20 power generation structure shares the same magnet set 1 with the generator 91 structure, thereby making the flywheel power generation system compact in structure and low in cost.

It can also be learned that the structure of the flywheel power generation system can be made more compact by using the accommodating chamber 201 on flywheel 20 to accommodate components such as the magnet set 1, the first brake member 3 and the second brake member 4. And it can make certain parts in the flywheel power generation system shareable, with low cost and easy assembly. In addition, in this embodiment, the first brake member 3 and the second brake member 4 are both made of aluminum, so the use cost is low.

In a specific embodiment, magnet set 1 comprises multiple pairs of NS magnetic poles, and the multiple pairs of NS magnetic poles are annularly arranged on the axial chamber wall of the accommodating chamber 201. The N and S poles of the NS magnetic poles are staggered, so when the flywheel 20 rotates, the N and S pole magnetic fields of the magnet set 1 quickly stagger through the stator coil 30. Due to the principle of magnetic electricity generation, induced current is generated to ensure the normal generation of current.

Further, the flywheel power generation system also comprises a battery 40. The battery 40 is provided on the bracket 2, and the battery 40 is configured to store the generated current. It can be understood that using the battery 40 to store current is more convenient for actual use. In addition, arranging the battery 40 on the bracket 2 means that the battery 40 is located in the accommodating chamber 201, which can further improve the compactness of the flywheel power generation system. It should be noted that the battery 40 is a prior art, and the connection method between the battery 40 and the above-mentioned motor 91 structure is also a prior art, and will not be described again.

In order to further improve the compactness of the flywheel power generation system, the driving device set 9 is installed on the bracket 2.

Preferably, the flywheel power generation system also comprises a first link member 5 and a second link member 6. One end of the first link member 5 is fixedly connected to the first movable end 32, and one end of the second link member 6 is fixedly connected to the second movable end 42. A first gear 7 and a second gear 8 are both rotatably arranged on the bracket 2, and the first gear 7 and the second gear 8 rotate in opposite directions. The first gear 7 comprises a first eccentric shaft, and the other end of the first link member 5 is rotatably connected to the first eccentric shaft. The second gear 8 comprises a second eccentric shaft, and the other end of the second link member 6 is rotatably connected to the second eccentric shaft. The first gear 7 meshes with the second gear 8. The driving device set 9 comprises the motor 91 and a transmission gear set 92. The motor 91 is arranged on the bracket 2. The first gear 7 or the second gear 8 and the motor 91 are transmitted through the transmission gear set 92.

It can be understood that in the above action, the first link member 5 and the second link member 6 drive the first brake member 3 and the second brake member 4 respectively, thereby effectively avoiding the problem in the prior art of using a steel cable to pull the magnet set 1 to the extreme position will cause it to get stuck, thereby avoiding the generation of noise and the burning of the motor 91. It is also understandable that if a program failure occurs in the upper control instrument, only the program of the upper control instrument needs to be adjusted. It is also understood that since the first gear 7 meshes with the second gear 8, that is, the first gear 7 and the second gear 8 can be synchronous rotated by driving either one of the first gear 7 or the second gear 8. As a result, the structure of the flywheel power generation system is more compact, and the consistency of rotation of the first gear 7 and the second gear 8 can be ensured. In addition, since the first gear 7 and the second gear 8 are directly meshed, it can be ensured that the directions of the two gears are always opposite.

Further, the transmission gear set 92 comprises a worm 921 and a plurality of intermediate gears 922. The worm 921 is coaxially fixed on the output shaft of the motor 91. The plurality of intermediate gears 922 engage and transmit one by one to form a transmission path arranged along a preset direction. The worm 921 meshes with the intermediate gear 922 located at the beginning of the transmission path, and the first gear 7 or second gear 8 meshes with the intermediate gear 922 located at the end of the transmission path. It can be understood that using the transmission method of the worm 921 can make the driving device set 9 have the advantages of high transmission efficiency, low noise and long service life. It should be noted that the intermediate gears 922 located at the starting end of the transmission path are fixedly provided with a worm gear that matches the worm 921. It should also be noted that in this embodiment, the number of intermediate gears 922 is three. In other embodiments, the number of intermediate gears 922 may also be five, seven or more.

In some embodiments, the flywheel power generation system also comprises an angle sensor (not shown in the figure). The angle sensor is used to detect the rotation angle of the first gear 7 or the second gear 8, so as to more accurately control the spacing between the magnet set and the brake member. It should be noted that the angle sensor can preferably be a photoelectric sensor in the prior art, which will not be described again. In addition, the installation position of the angle sensor can be selected according to the actual application scenario, such as in the driving device set 9 mentioned above. Using an angle sensor to detect the rotation angle of the first gear 7, the second gear 8 or any intermediate gear 922, the rotation angle of the first gear 7 and the second gear 8 can be obtained.

In some embodiments, the flywheel power generation system also comprises a fixing member 21 that is rotationally connected to the rotating shaft 10. The fixing member 21 is configured to cooperate with the bracket 2 to fix the components located on the bracket 2, thereby helping to ensure the stability of the flywheel power generation system. It should be noted that the matching method between the fixing member 21 and the bracket 2 can be any convenient implementation method such as snap connection or screw connection.

This embodiment also provides an exercise bike, which comprises the above-mentioned flywheel power generation system, so that the exercise bike has a more compact structure and low cost.

In summary, the present invention can be summarized as having the following industrial utilization values:

1. The first movable end and the second movable end are driven toward or away from each other by the driving device set, that is, the gap between the first brake member, the second brake member and the magnet set can be adjusted, and the riding resistance can be adjusted.

2. When the flywheel rotates, it can drive the magnet set to rotate synchronously. When the magnet set passes through the stator coil, it cuts the magnetic field to generate electromotive force to form an induced current, that is, to generate electrical energy.

3. The resistance adjustment mechanism and the power generation mechanism in the flywheel power generation structure share the same magnet set, making the flywheel power generation system compact and low-cost.

4. Using the accommodating chamber on the flywheel to accommodate components such as the magnet set, first brake member, and second brake member can make the structure of the flywheel power generation system more compact, and it can make certain parts in the flywheel power generation system shareable, with low cost and easy assembly.

5. You can also choose not to use the motor.

What is claimed is:

1. A flywheel power generation system, comprising:
a rotating shaft;
a flywheel fixedly connected to said rotating shaft, said flywheel comprising a circular accommodating chamber;
a magnet set fixedly installed on a circumferential chamber wall of said accommodating chamber;
a bracket rotationally connected to said rotating shaft;
a first brake member arranged in an arc shape, said first brake member comprising a first fixed end and a first movable end, said first fixed end being rotatably arranged on said bracket;
a second brake member arranged in an arc shape, said second brake member comprising a second fixed end and a second movable end, said second fixed end being rotatably arranged on said bracket, said second brake member cooperating with said first brake member to achieve a shape similar to said magnet set;
a first gear and a second gear both rotatably arranged on said bracket, said first gear and said second gear rotating in opposite directions, said first gear comprising a first eccentric shaft, said second gear comprising a second eccentric shaft; and
a driving device set configured to drive said first movable end and said second movable end toward or away from each other.

2. The flywheel power generation system as claimed in claim 1, wherein said magnet set comprises multiple pairs of NS magnetic poles arranged annularly on an axial chamber wall of said accommodating chamber, the N poles and S poles of said NS magnetic poles being distributed in a staggered manner.

3. The flywheel power generation system as claimed in claim 1, further comprising a battery disposed on said bracket, said battery being configured to store the generated electrical current.

2. The flywheel power generation system as claimed in claim 1, further comprising:
a first gear and a second gear are both rotatably arranged on said bracket to rotate in opposite directions, said bracket also having said driving device set thereon the bracket, said first gear comprising a first eccentric shaft, said second gear comprising a second eccentric shaft; and
a first link member and a second link member, said first link member having one end thereof fixedly connected to said first movable end and an opposite end thereof rotationally connected to said first eccentric shaft, said second link member having one end thereof fixedly connected to said second movable end and an opposite end thereof rotationally connected to said second eccentric shaft.

5. The flywheel power generation system as claimed in claim 4, wherein said first gear meshes with said second gear; said driving device set comprises a motor arranged on said bracket, and a transmission gear set so configured that said first gear or said second gear and said motor are transmitted through said transmission gear set.

6. The flywheel power generation system as claimed in claim 5, wherein said transmission gear set comprises a worm coaxially fixed on the output shaft of said motor; and a plurality of intermediate gears, said intermediate gears engaging and transmitting one by one to form a transmission path arranged along a preset direction, so that said worm meshes with the said intermediate gear located at the beginning of said transmission path, and said first gear or second gear meshes with the said intermediate gear located at the end of said transmission path.

7. The flywheel power generation system as claimed in claim 6, further comprising an angle sensor for detecting the rotation angle of said first gear or said second gear.

8. The flywheel power generation system as claimed in claim 1, wherein said fixing member is configured to cooperate with said bracket to fix components located on said bracket.

9. An exercise bike comprising the said flywheel power generation system as claimed in claim 1.
